(19) United States
(12) Patent Application Publication
(10) Pub. No.: US 2006/0112323 A1
(43) Pub. Date: May 25, 2006

(54) Method, system, and storage medium for providing adaptive, selectable print options

(75) Inventors: Gregory J. Boss, American Fork, UT (US); Rick A. Hamilton II, Charlottesville, VA (US); Nicholas R. Trio, Carmel, NY (US); Timothy M. Waters, Hiram, GA (US)

Correspondence Address: CANTOR COLBURN LLP-IBM YORKTOWN, 55 GRIFFIN ROAD SOUTH, BLOOMFIELD, CT, 06002, US

(73) Assignee: International Business Machines Corporation, Armonk, NY (US)

(21) Appl. No.: 10/995,674

(22) Filed: Nov. 23, 2004

(51) Int. Cl. G06F 17/21

(52) U.S. Cl. 715/500

(57) ABSTRACT

A method for providing adaptive, selectable print options. The method includes parsing a document into logical sections, each of the logical sections identified by a reference. The method also includes creating a print map of references identified as a result of the parsing, displaying the print map along with selectable print options, and executing a print operation in response to a selected print option. The selected print option specifies a reference from the print map. A logical section associated with the reference is transmitted to a printer for printing.

### BACKGROUND

Embodiments of the invention relate generally to computer printing functions, and more particularly, to a method, system, and storage medium for providing adaptive, selectable print options.

In a typical computing environment, the ability to print a particular document section is limited to the end user task of searching through the document and determining the beginning and ending page numbers of the desired section. Once this information has been ascertained, the user then selects the page numbers corresponding to the desired section to print. Currently, there exists no print driver-based system for determining the beginning and ending page numbers of a particular section of a document.

Moreover, because the pagination of a document's page numbers oftentimes differs dramatically from the countable pages (i.e., the absolute page numbers differ from the relative pages numbers), the end user would need to scroll through the document, determine the beginning and ending page numbers of that particular portion of the document, and then print the required portion using absolute page numbers. This method is time consuming, prone to error, may result in unnecessary paper waste, and may cause multiple queuing events to be executed for a single print job. Clearly, existing print option capabilities may contribute to diminished workplace performance and sub-optimal working conditions in an office environment.

What is needed, therefore, is a way to provide flexible print options for implementation regarding portions of a document without requiring specific page information. What is also needed is a way to ensure the accurate printing of only the desired sections of a document.

### SUMMARY

Exemplary embodiments relate to a method, system, and storage medium for providing adaptive, selectable print options. The method includes parsing a document into logical sections, each of the logical sections identified by a reference. The method also includes creating a print map of references identified as a result of the parsing, displaying the print map along with selectable print options, and executing a print operation in response to a selected print option. The selected print option specifies a reference from the print map. A logical section associated with the reference is transmitted to a printer for printing.

The computer system for providing adaptive, selectable print options includes a word processing application executing on the computer system, a document being created or edited on the computer system via the word processing application, and a print agent executing on the computer system. The print agent interfaces with the word processing application. The print agent parses the document into logical sections. Each of the logical sections is identified by a reference. The print agent also creates a print map of references identified as a result of the parsing. The computer system also includes a display device operable for displaying the print map and selectable print options generated by the print agent, and a print operation executed on the computer system. The print operation is executed in response to a selected print option. The selected print option specifies a reference from the print map. A logical section associated with the reference is transmitted to a printer for printing.

The storage medium is encoded with machine-readable program code for providing adaptive, selectable print options. The program code includes instructions for causing a processor to implement a method. The method includes parsing a document into logical sections, each of the logical sections identified by a reference. The method also includes creating a print map of references identified as a result of the parsing, displaying the print map along with selectable print options, and executing a print operation in response to a selected print option. The selected print option specifies a reference from the print map. A logical section associated with the reference is transmitted to a printer for printing.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a user interface screen depicting a print window provided by a legacy application as implemented in the prior art;

FIG. 2 is a user interface screen depicting a print window provided by a second legacy application as implemented in the prior art;

FIG. 3 is a block diagram of a system upon which the print driver system may be implemented in exemplary embodiments;

FIG. 4 is a flow diagram illustrating a process for implementing the print driver system in exemplary embodiments; and

FIG. 5 is a user interface screen depicting a print window including a sample adaptive print menu in exemplary embodiments.

### DETAILED DESCRIPTION OF EXEMPLARY EMBODIMENTS

In accordance with exemplary embodiments, a method, system, and storage medium for providing adaptive, selectable print options is provided. The print driver system of the invention enables an end user of a computer system to identify and select sections of document for printing without the need to associate page numbers of the desired document sections. The print driver system parses through documents being created or edited, identifies logical sections (and references to those sections), builds a print map of the document sections with references, and provides selectable print options to the end user that allows the end user to print only the desired sections.

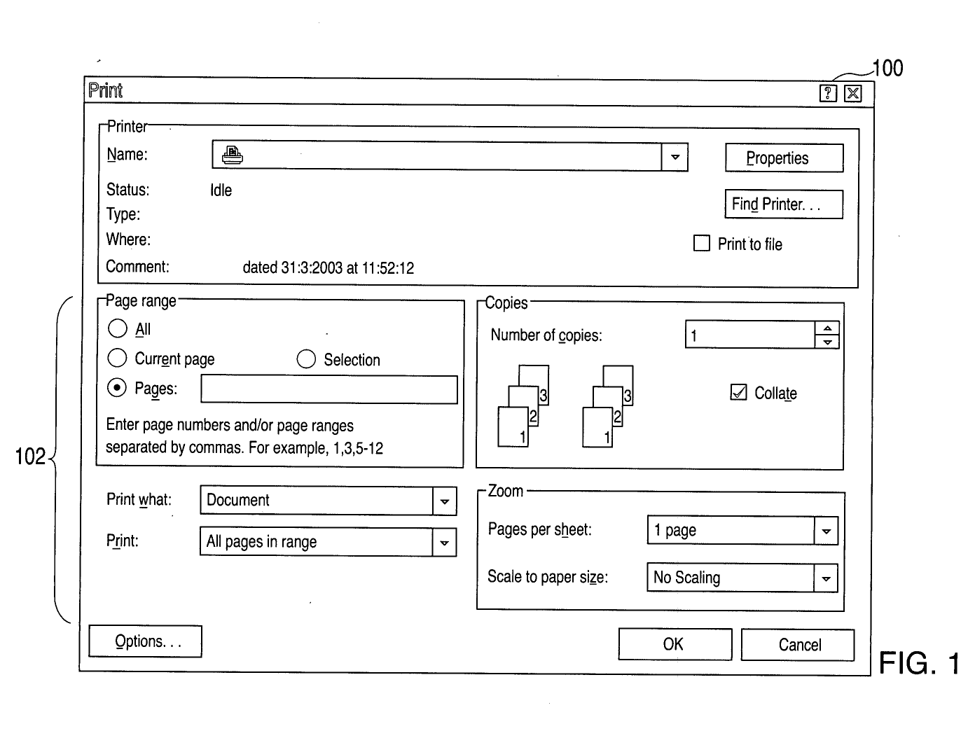

Printing capabilities provided by existing software are well known by those skilled in the art. These capabilities generally relate to print layout, print range, and printer selection functions. The user interface screen of FIG. 1 illustrates an example of a print window 100 provided by Microsoft® Word. As shown in FIG. 1, print range options are limited to a page range 102.

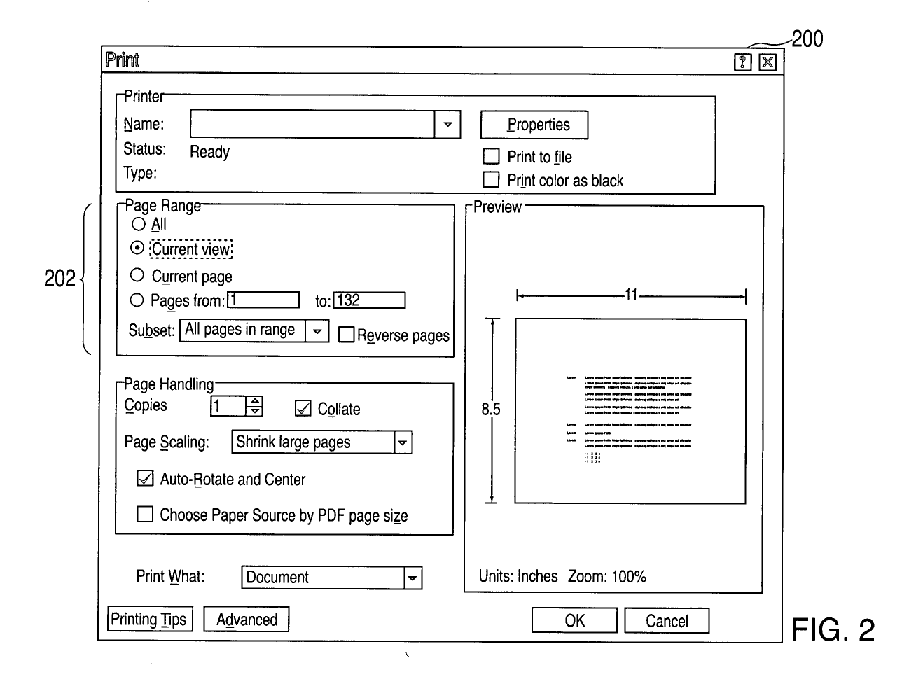

Another example of print capabilities is shown generally in FIG. 2. The user interface screen of FIG. 2 illustrates an example of a print window 200 provided by Adobe® Acrobat. Again, as shown in FIG. 2, print range options are also limited to a page range 202.

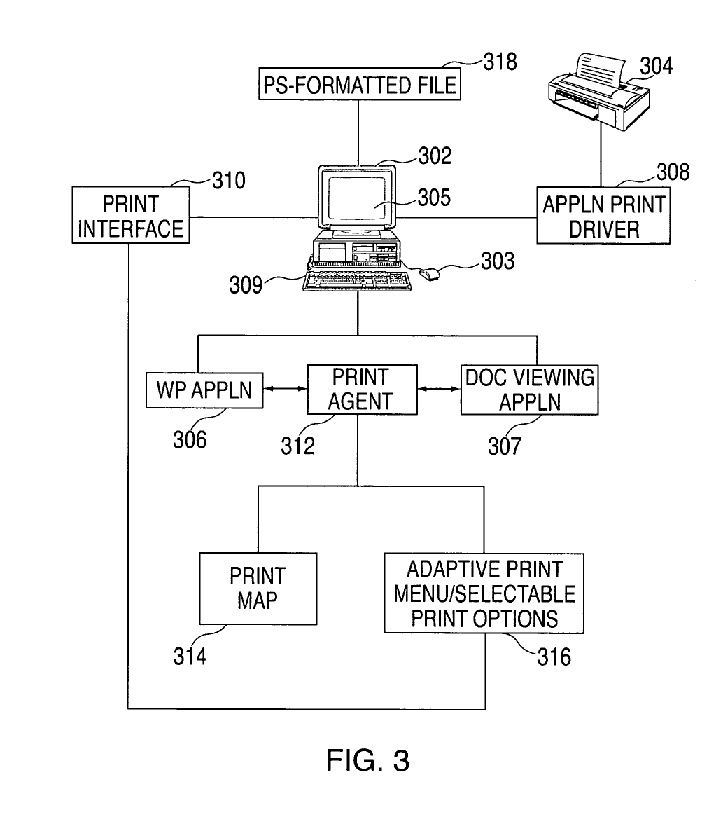

As indicated above, the print driver system enables a print driver for a particular word processing software package to print a section of a document by providing a print menu option. Turning now to FIG. 3, a block diagram of a system upon which the print driver system may be implemented in exemplary embodiments will now be described. The system includes a computer system 302 including one or more input devices (e.g., keyboard 309, mouse 303) and one or more output devices (e.g., display screen 305, printer 304). The computer system 302 may be implemented using a general-purpose computer executing a computer program for carrying out some of the processes described herein. The computer system 302 may be a personal computer (e.g., a lap top, a personal digital assistant) or host-attached terminal if, for example, computer system 302 is part of a network of computers. If part of a network of computers, the processing described herein may be shared by computer system 302 and a host system in communication with the computer system 302 over a network (e.g., local area network).

Computer system 302 executes one or more word processing applications (e.g., word processing application 306), which may be one of various software applications known in the art (e.g., Lotus® WordPro, Microsoft® Word, Corel® WordPerfect). A document viewing application 307 (also referred to as a document viewer) is also running on computer system 302. Document viewing application 307 enables an end user of computer system 302 to view a document on the display screen 305 in one of several modes, such as print mode, normal, web, etc. An example of a document viewing application 307 is Word 97/2000 Viewer, which is implemented for Microsoft® Word.

Word processing application 306 includes an application print driver 308 that enables the computer system 302 to convey to printer 304 the print requirements (e.g., formatting, settings, and protocols) associated with the application 306. A print interface 310 is provided on the display screen 305 of computer system 302 for assisting the end user in selecting one or more print options available for the particular word processing application. Sample print interfaces are shown in FIGS. 1 and 2.

The print range system includes a print agent 312 that interfaces with the word processing application 306 as well as the document viewing application 307. A print map 314 is generated by the print agent 312 utilizing contents of a document created via the word processing application 306. Print map 314 may include references to the logical sections of a document that are parsed by the print agent 312, as well as pointers or addresses of the logical sections. The references provide descriptive information of the nature or contents of the logical sections to an end user so that the end user can easily identify each of the logical sections during a print operation.

An adaptive print menu 316 is created from the print map 314 by the print agent 312. The adaptive print menu 316 provides some assistance to the end user desiring to print one or more sections of a document. The adaptive print menu 316 may include selectable print options that enable a user to quickly select a desired section for printing including the section's beginning and end points without the requirement that associated page numbers be identified.

As indicated above, printer 304 is associated with computer system 302. Printer 304 is coupled to computer system 302 and receives requests or print jobs from computer system 302. Printer 304 may be in communication with computer system 302 either wirelessly (e.g., BlueTooth™) or may be physically coupled via cabling and/or through a network.

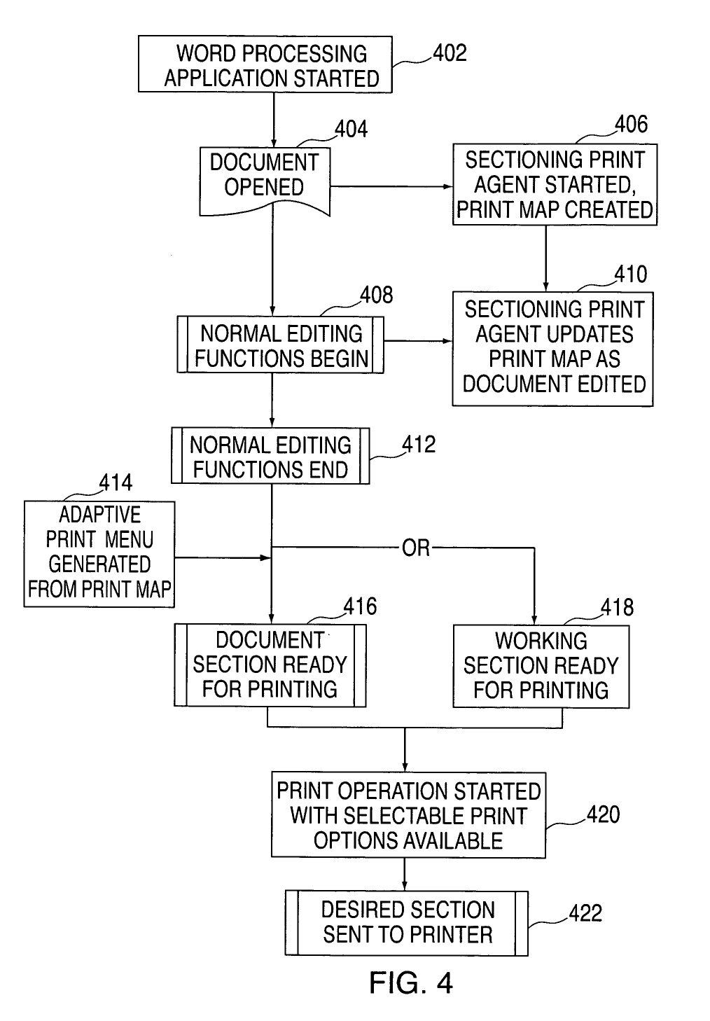

Turning now to FIG. 4, a flow diagram illustrating a process for implementing adaptive, selectable print activities in exemplary embodiments will now be described. The process begins at step 402 whereby a user of client system 102 initiates the word processing application 306. The user may either create a new document or open an existing (saved) document at step 404. This step 404 causes the print agent 312 to be initiated at step 406. The user may perform typical editing functions on the document (e.g., adding text or images, editing text or images, formatting text (e.g., bold, underline, italic functions, etc.) at step 408. As the document is being created or edited, the print agent 312 dynamically scans and parses through the document, looking for patterns that denote logical sections such as chapters, outline sections, table of contents, glossary, pictures, etc. based on the particular application's embedded metadata or meta-text for the working document. The agent 312 assimilates pointers to beginning and ending page numbers and lines within a page for purposes of generating the postscript (PS), page character language (PCL), or any other format of the print job to be sent to the printer 304. These pointers collectively form the print map 314, which then serves as the logical addressing for the print agent 312.

Alternatively, if the word processing application 306 utilizes a document map (e.g., map containing formatting codes for enabling quick access or hyperlinks to other portions of a document), the print agent 312 may create the print map 314 from the document map. The print agent 312 would then assimilate the print map 314 containing the page numbers and line numbers. The print map 314 contains the beginning and end pages and line numbers of the logical sections. For purposes of illustration, sample print map data are provided below.

Chapter 3, absolute begin page number, 59

Chapter 3, absolute end page number, 102

FIG. 8, absolute page number, 32, begin line number, 12

FIG. 8, absolute page number, 32, end line number, 22

During the editing process, the print agent 312 updates the print map 314 at step 410 to reflect the edits (e.g., changing the pointers as figures are added or sub-sections are removed, etc.). This updating is based upon the particular editing activities being performed in step 408. Once the editing functions are completed at step 412, or upon a desire to print a section of an active, working document, the print agent 312 builds an adaptive print menu 316 from the print map 314 at step 414.

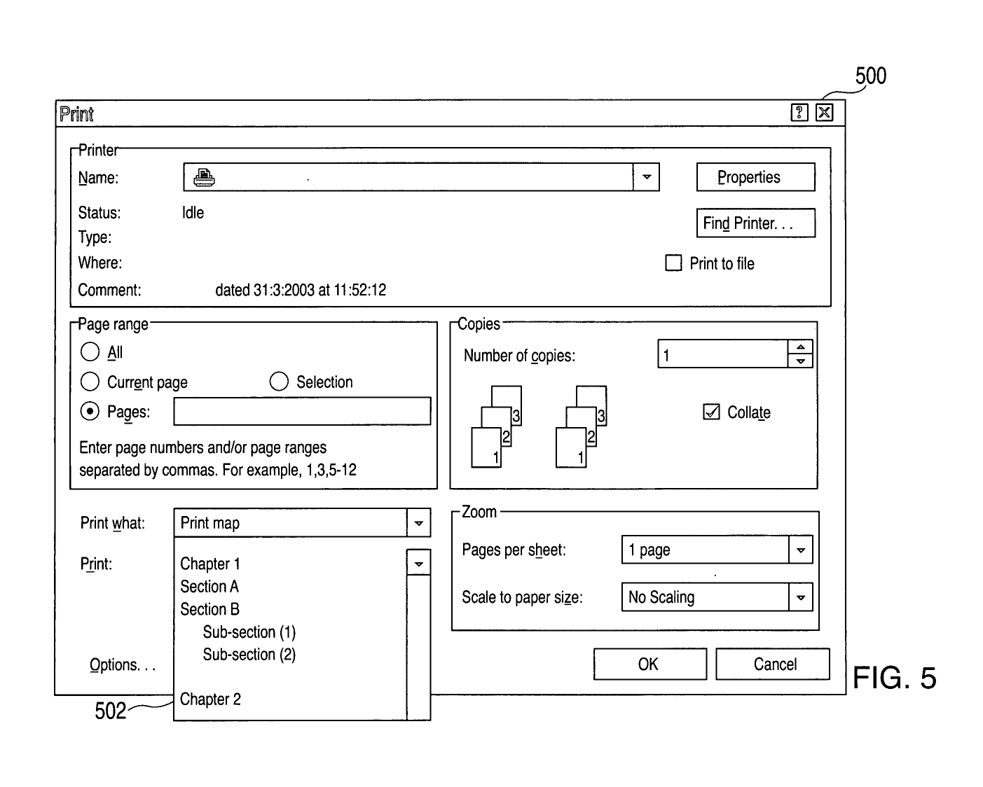

The user identifies a document section for printing at step 416 or, alternatively, a working section of the document for printing at step 418. The user then initiates a print operation at step 420. The print driver system may accomplish this print operation in various ways. For example, the user may place a cursor over a selected portion of the document and right-click the mouse 303. The adaptive print menu 316 is presented in a pop up window on the display of computer system 302. Alternatively, the user may select a print option from the toolbar or by other means whereby the print interface 310 is presented along with the adaptive print menu 316. The legacy print interface 310 is presented to the user on the display of computer system 302. The adaptive print menu 316 is provided to the print interface 310 along with selectable print options. A sample print interface including selectable print options is shown in the print interface window 500 of FIG. 5.

The user selects options from the adaptive print menu 316 and completes the print operation. Once a section is chosen for printing, the print agent 312 communicates the selected section for printing to the print driver 308 of the word processing application 306. The word processing application 306 then creates the PS-formatted file 318 to be sent to the printer 304. The PS-formatted file 318 is then sent to the printer 304 at step 422.

In alternative embodiments, a clipboard (e.g., clipboard as utilized in Microsoft(D Office) may be incorporated into the print driver system. The print clipboard may hold the user selectable print selections in the computer system's 302 memory. The end user would select specific sections of the document to print immediately or may choose to print to the clipboard. When desired, the end user would print the contents of the print clipboard, which contains all of the end user's printing selections from the document. The print driver system would prepare the print job in, e.g., PS format, and then send the print job to the printer 304.

As described above, the embodiments of the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for providing adaptive, selectable print options, comprising:
parsing a document into logical sections, each of the logical sections identified by a reference;
creating a print map of references identified as a result of the parsing;
displaying the print map along with selectable print options; and
executing a print operation in response to a selected print option, the selected print option specifying a reference from the print map;
wherein a logical section associated with the reference is transmitted to a printer for printing.

2. The method of claim 1, further comprising:
continuously updating the print map in accordance with editing functions performed on the document.

3. The method of claim 2, wherein the editing functions include at least one of:
adding text or images to the document;
changing text or images in the document; and
formatting text or images in the document.

4. The method of claim 1, wherein the parsing includes:
identifying patterns in the document that denote logical sections based upon an application's embedded metadata or meta-text associated with the document.

5. The method of claim 4, wherein the logical sections are determined by at least one of:
chapters;
outline sections;
tables of contents;
glossaries; and
images.

6. The method of claim 1, wherein the parsing further includes:
assimilating pointers to beginning and ending page numbers; and
assimilating pointers to line numbers within a page;
wherein the assimilating is operable for performing logical addressing of the logical sections, the logical addressing utilized by the print agent in creating the print map.

7. The method of claim 1, further comprising:
incorporating the print map and selectable print options into a print driver of an application, the document derived from the application; and
presenting the print map and selectable print options via a print interface associated with the print driver.

8. A computer system for providing adaptive, selectable print options, comprising:
a word processing application executing on the computer system;
a document opened on the computer system via the word processing application;
a print agent executing on the computer system, the print agent interfacing with the word processing application, the print agent operable for:
parsing the document into logical sections, each of the logical sections identified by a reference; and
creating a print map of references identified as a result of the parsing;
a display device operable for displaying the print map and selectable print options generated by the print agent; and
a print operation executed on the computer system, the print operation executed in response to a selected print option, the selected print option specifying a reference from the print map;
wherein a logical section associated with the reference is transmitted to a printer for printing.

9. The system of claim 8, wherein the print agent further performs:
continuously updating the print map in accordance with editing functions performed on the document.

10. The system of claim 9, wherein the editing functions include at least one of:
adding text or images to the document;
changing text or images in the document; and
formatting text or images in the document.

11. The system of claim 8, wherein the parsing includes:
identifying patterns in the document that denote logical sections based upon an application's embedded metadata or meta-text associated with the document.

12. The system of claim 11, wherein the logical sections are determined by at least one of:
chapters;
outline sections;
tables of contents;
glossaries; and
images.

13. The system of claim 8, wherein the parsing further includes:
assimilating pointers to beginning and ending page numbers; and
assimilating pointers to line numbers within a page;
wherein the assimilating is operable for performing logical addressing of the logical sections, the logical addressing utilized by the print agent in creating the print map.

14. A storage medium encoded with machine-readable program code for providing adaptive, selectable print options, the program code including instructions for causing a computer to implement a method, comprising:
parsing a document into logical sections, each of the logical sections identified by a reference;
creating a print map of references identified as a result of the parsing;
displaying the print map along with selectable print options; and
executing a print operation in response to a selected print option, the selected print option specifying a reference from the print map;
wherein a logical section associated with the reference is transmitted to a printer for printing.

15. The storage medium of claim 14, further comprising instructions for causing the computer to implement:
continuously updating the print map in accordance with editing functions performed on the document.

16. The storage medium of claim 15, wherein the editing functions include at least one of:
adding text or images to the document;
changing text or images in the document; and
formatting text or images in the document.

17. The storage medium of claim 14, wherein the parsing includes:
identifying patterns in the document that denote logical sections based upon an application's embedded metadata or meta-text associated with the document.

18. The storage medium of claim 17, wherein the logical sections are determined by at least one of:
chapters;
outline sections;
tables of contents;
glossaries; and
images.

19. The storage medium of claim 14, wherein the parsing further includes:
assimilating pointers to beginning and ending page numbers; and
assimilating pointers to line numbers within a page;
wherein the assimilating is operable for performing logical addressing of the logical sections, the logical addressing utilized by the print agent in creating the print map.

20. The storage medium of claim 14, further comprising instructions for causing the computer to implement:
incorporating the print map and selectable print options into a print driver of an application, the document derived from the application; and
presenting the print map and selectable print options via a print interface associated with the print driver.
